(19) United States
(12) Patent Application Publication
(10) Pub. No.: US 2016/0375899 A1
(43) Pub. Date: Dec. 29, 2016

(54) VEHICLE CONTROL DEVICE

(71) Applicant: TOYOTA JIDOSHA KABUSHIKI KAISHA, Toyota-shi, Aichi-ken (JP)

(72) Inventor: Kenichi TAKENAKA, Chiryu-shi, Aichi-ken (JP)

(73) Assignee: TOYOTA JIDOSHA KABUSHIKI KAISHA, Toyota-shi, Aichi-ken (JP)

(21) Appl. No.: 15/113,611

(22) PCT Filed: Jan. 26, 2015
(86) PCT No.: PCT/IB2015/000061

§ 371 Date: Jul. 22, 2016

(30) Foreign Application Priority Data
Jan. 28, 2014 (JP) 2014-013771

(51) Int. Cl. B60W 30/08; B60W 10/20; B60W 10/30; B60W 30/12; B60W 10/18

(52) U.S. Cl. CPC B60W 30/08; B60W 30/12; B60W 10/18; B60W 10/30; B60W 10/20; B60W 2030/082; B60W 2540/10; B60W 2550/20; B60W 2710/18; B60W 2710/20

(57) ABSTRACT

The invention is provided with airbag control means for deploying an external airbag in a case where a magnitude of a collision detected by a first collision detection sensor satisfies a deployment condition for the external airbag and deploying an internal airbag in a case where a magnitude of a collision detected by a second collision detection sensor satisfies a deployment condition for the internal airbag, and braking control means for performing automatic brake control when the internal airbag is deployed. The braking control means performs the automatic brake control when the external airbag is deployed even in a case where the deployment condition for the external airbag is satisfied but the deployment condition for the internal airbag is not satisfied.

### BACKGROUND OF THE INVENTION

1. Field of the Invention

The invention relates to a vehicle control device.

2. Description of Related Art

Techniques for deploying an external airbag for pedestrian protection outside a vehicle along a front surface of a front window when a collision with a pedestrian is detected have been reported (Japanese Patent Application Publication No. 2006-218918 (JP 2006-218918 A) and the like). Also, techniques for deploying an internal airbag for passenger protection and automatically operating a brake in a case where a collision with an external obstacle such as another vehicle is detected have been reported (Japanese Patent Application Publication No. 6-234342 (JP 6-234342 A), Japanese Patent Application Publication No. 2012-1091 (JP 2012-1091 A), and the like).

In the related technique (JP 2006-218918 A and the like) for deploying the external airbag after the detection of the collision with the pedestrian including a bicycle rider, the external airbag for pedestrian protection is deployed on the front surface of the front window, as illustrated in FIG. 1, so as to reduce impairment attributable to the collision with a pillar portion and a cowl portion which rarely can be weakened in view of body structure. Accordingly, a situation in which a forward visibility of a driver is impeded may occur when the external airbag is deployed after the detection of the collision with the pedestrian. A possibility of a secondary collision with the external obstacle increases when the vehicle is allowed to travel by the driver whose forward visibility is impeded in such a situation.

In the related techniques (JP 6-234342 A, JP 2012-1091 A, and the like) for deploying the, internal airbag and operating the automatic brake after the detection of the collision with the external obstacle, a condition for deploying the internal airbag for passenger protection may not be satisfied during the collision with the pedestrian in, for example, a case where magnitude of the collision with the pedestrian in which a deployment condition for the external airbag for pedestrian protection is assumed is set to be smaller than a magnitude of the collision with the external obstacle in which a deployment condition for the internal airbag for passenger protection is assumed.

As described above, the automatic brake may not be operated in a case where the deployment condition for the internal airbag for passenger protection is not satisfied in a state where the forward visibility of the driver is impeded by the deployment of the external airbag for pedestrian protection after the detection of the collision with the pedestrian according to the related techniques.

### SUMMARY OF THE INVENTION

The invention provides a vehicle control device that is capable of suppressing secondary collision damage, which may occur when a forward visibility of a driver is obstructed due to deployment of an external airbag for pedestrian protection after a collision with a pedestrian is detected, even in a condition in which an internal airbag for passenger protection is not deployed.

An aspect of the invention relates to a vehicle control device. The vehicle control device includes a first collision detection sensor that detects a collision with a pedestrian; a second collision detection sensor that detects a collision with an external obstacle; an external airbag that is deployed ahead of a front window of a main vehicle so as to protect the pedestrian; an internal airbag that is deployed in a passenger compartment so as to protect a passenger in the main vehicle; airbag control means for deploying the external airbag in a case where a magnitude of the collision detected by the first collision detection sensor satisfies a deployment condition for the external airbag and, deploying the internal airbag in a case where a magnitude of the collision detected by the second collision detection sensor satisfies a deployment condition for the internal airbag which is different from the deployment condition for the external airbag; and braking control means for performing automatic brake control when the internal airbag is deployed by the airbag control means in a case where the deployment condition for the internal airbag is satisfied and performing the automatic brake control when the external airbag is deployed by the airbag control means in a case where the deployment condition for the external airbag is satisfied but the deployment condition for the internal airbag is not satisfied.

In the above-described aspect, it is preferable that the deployment condition for the internal airbag be set for the internal airbag to be deployed when a variable showing the magnitude of the collision is equal to or higher than a first threshold, and the deployment condition for the external airbag be set for the external airbag to be deployed when a variable different in type from the variable showing the magnitude of the collision set as the deployment condition for the internal airbag is equal to or higher than a second threshold.

In the above-described aspect, the deployment condition for the internal airbag may be set for the internal airbag to be deployed when a variable showing the magnitude of the collision is equal to or higher than a first threshold, and the deployment condition for the external airbag may be set for the external airbag to be deployed when a variable of the same type as the variable-showing the magnitude of the collision set as the deployment condition for the internal airbag is equal to or higher than a second threshold lower than the first threshold.

In the above-described aspect, steering control means for performing automatic steering control so that the main vehicle does not deviate from a lane of the main vehicle may be further provided, in which the steering control means may perform the automatic steering control with the automatic brake control by the braking control means performed when the external airbag is deployed by the airbag control means.

In the above-described aspect, the braking control means may not, release the automatic brake control within a first predetermined time, even when an accelerator operation is detected, in a condition in which the automatic brake control is released and may release the automatic brake control in a case where a second predetermined time longer than the first predetermined time is exceeded, even when the accelerator operation by a driver is not detected, in a case where the accelerator operation by the driver of the main vehicle is detected during the automatic brake control.

According to the above-described aspect, the external airbag for pedestrian protection can be deployed and a brake can be automatically operated, even in the condition in which the internal airbag for passenger protection is not deployed, after the detection of the collision with the pedestrian. Accordingly, a vehicle control device capable of suppressing the secondary collision damage that may occur when the forward visibility of the driver is obstructed due to the deployment of the external airbag for pedestrian protection after the detection of the collision with the pedestrian can be provided according to the invention.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a drawing illustrating a situation in which a forward visibility of a driver is impeded when an external airbag is deployed after a collision with a pedestrian is detected;

FIG. 2 is a diagram illustrating a configuration of a vehicle control device according to the invention;

FIG. 3 is a drawing illustrating an example of situations in which the external airbag is deployed when the collision with the pedestrian is detected;

FIG. 4 is a flowchart illustrating an example of basic processing of the vehicle control device according to the invention;

FIG. 5 is a flowchart illustrating another example of the basic processing of the vehicle control device according to the invention; and

FIG. 6 is a diagram illustrating an example of automatic brake control release processing.

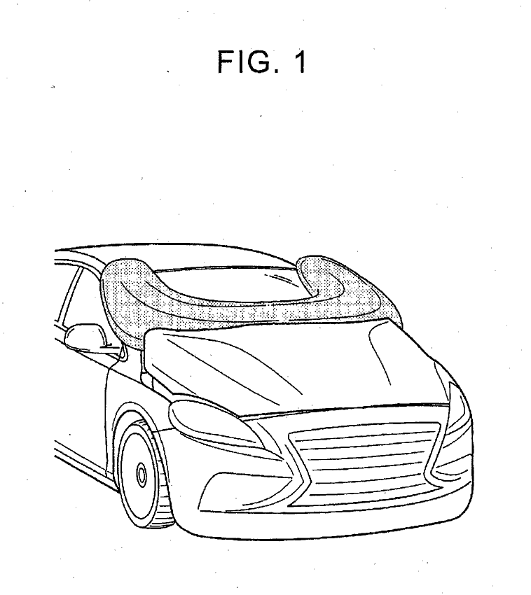

### DETAILED DESCRIPTION OF EMBODIMENTS

Hereinafter, an embodiment of a vehicle control device according to the invention will be described in detail with reference to drawings. The invention is not limited to this embodiment. Configuration elements of the embodiment described below include those that can be easily assumed by those skilled in the art or those that are substantially identical thereto.

### Embodiment

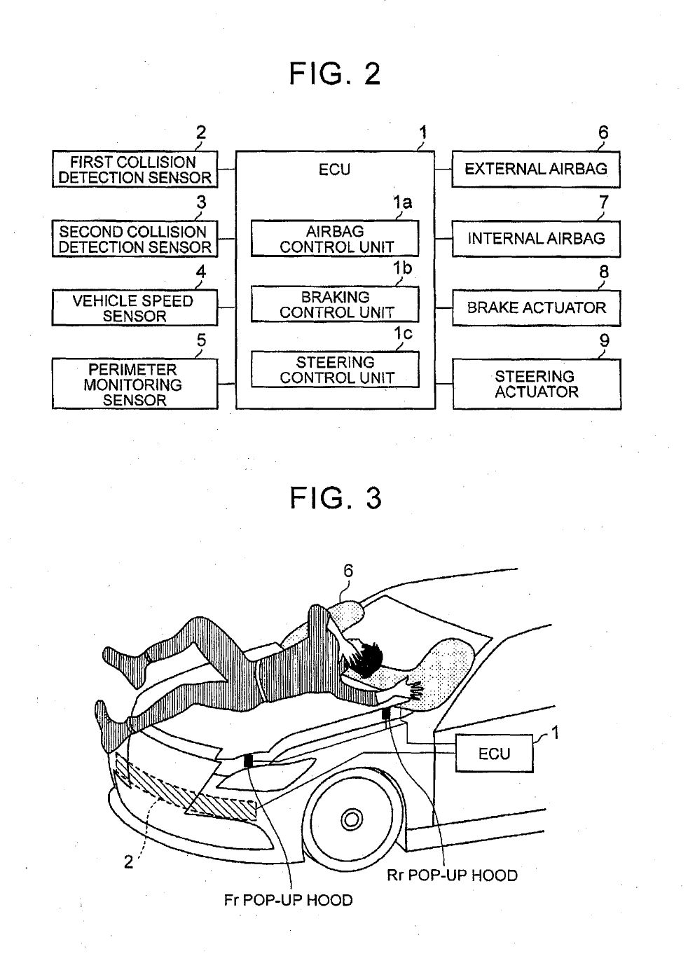

A configuration of the vehicle control device according to the invention will be described with reference to FIGS. 2 and 3. FIG. 2 is a diagram illustrating the configuration of a vehicle control device according to the invention. FIG. 3 is a drawing illustrating an example of situations in which an external airbag is deployed when a collision with a pedestrian is detected.

The vehicle control device according to this embodiment, is mounted on a vehicle (main vehicle). Typically, the vehicle control device according to this embodiment is provided with an ECU 1, a first collision detection sensor 2, a second collision detection sensor 3, a vehicle speed sensor 4, a perimeter monitoring sensor 5, an external airbag 6, an internal airbag 7, a brake actuator 8, and a steering actuator. 9 as illustrated in FIG. 2.

As illustrated in FIG. 2, the ECU 1, which controls driving of each unit of the vehicle, is an electronic control unit in which a known microcomputer including a CPU, a ROM, a RAM, and an interface is a main agent. The ECU 1 is electrically connected to the first collision detection sensor 2, the second collision detection sensor 3, the vehicle speed sensor 4, and the perimeter monitoring sensor 5. Electrical signals corresponding to detection results are input into the ECU 1. The ECU 1 performs various types of computation processing in response to the electrical signals corresponding to the detection results and outputs control commands corresponding to computation results so as to control operations of the various mechanisms (the external airbag 6, the internal airbag 7, the brake actuator 8, the steering actuator 9, and the like) which are electrically connected to the ECU 1. Details of various processing units the ECU 1 is provided with (an airbag control unit 1a, a braking control unit 1b, a steering control unit 1c, and the like) will be described in detail later.

The first collision detection sensor 2 is a personal collision detection sensor that detects collisions with pedestrians including bicycle riders. The first collision detection sensor 2 is, for example, a pressure sensor or an optical fiber sensor. The first collision detection sensor 2 may be an acceleration sensor. The first collision detection sensor 2 is mounted, for example, on a chamber ASSY that has a chamber (or a tube) which is installed at an Fr bumper and a bumper absorber. The first collision detection sensor 2 outputs an electrical signal that shows a magnitude of the collision which is detected to the ECU 1. In this embodiment, the first collision detection sensor 2 is a sensor that detects the collision which triggers deployment of the external airbag 6 for pedestrian protection. The first collision detection sensor 2 has a detection range that allows the detection of the collision with an object with a mass, such as the pedestrian and the bicycle rider, that may be placed on a hood of the main vehicle and collide with a pillar portion and a cowl portion around a front window during the collision. An operating level of the first collision detection sensor 2 is set for a light collision through which a minor impairment is left on the bumper on the vehicle side.

The second collision detection sensor 3 is an object collision detection sensor that is different from the first collision detection sensor 2 in that the second collision detection sensor 3 detects a collision with an external obstacle. The second collision detection sensor 3 is, for example, an acceleration sensor. The second collision detection sensor 3 is mounted at a vehicle center side position compared to the mounting position of the first collision detection sensor 2. Examples of the external obstacle include another vehicle, a telephone pole, an obstacle, a guardrail, and a wall surface. The second collision detection sensor 3 outputs an electrical signal that shows a magnitude of the collision which is detected to the ECU 1. In this embodiment, the second collision detection sensor 3 is a sensor that detects the collision which triggers deployment of the internal airbag 7 for passenger protection. The second collision detection sensor 3 is assumed to detect the collision with the object such as the external obstacle that is heavier in mass than the object such as the pedestrian and the bicycle rider that may be placed on the hood of the main vehicle and collide with the pillar portion and the cowl portion around the front window during the collision. An operating level of the second collision detection sensor 3 is set for a medium collision/heavy collision through which a clear plastic change is left in an auto part around an Fr body on the vehicle side.

The vehicle speed sensor 4 is disposed in each of vehicle wheels. The vehicle speed sensors 4 are vehicle wheel speed detection devices that detect speeds of the respective vehicle wheels. The vehicle speed sensors 4 detect the vehicle wheel speeds that are rotational speeds of the respective vehicle wheels. The vehicle speed sensors 4 output electrical signals that, show the vehicle wheel speeds of the respective vehicle wheels which are detected to the ECU 1. The ECU 1 calculates a vehicle speed, which is a travel speed of the vehicle, based on the vehicle wheel speeds of the respective vehicle wheels that are input from the vehicle speed sensors 4. The ECU 1 may calculate the vehicle speed based on the vehicle wheel speed that is input from at least one of the vehicle speed sensors 4.

The perimeter monitoring sensor 5, which detects objects around the vehicle, is a perimeter monitoring device that performs white line detection and target object detection. The perimeter monitoring sensor 5 detects a white line, which is disposed in a travel path where the vehicle travels, for the white line detection. The perimeter monitoring sensor 5 detects three-dimensional objects around the vehicle, such as a pedestrian, a bicycle, another vehicle, a telephone pole, an obstacle, a guardrail, and a wall surface, for the target object detection. The perimeter monitoring sensor 5 is configured to have, for example, a millimeter wave sensor, a camera sensor, and a clearance sonar sensor. The perimeter monitoring sensor 5 outputs an electrical signal that shows white line information based on the white line detection and target object information based on the target object detection to the ECU 1.

The external airbag 6 is an airbag for pedestrian protection that is deployed ahead of the front window of the main vehicle so as to protect the pedestrian during the collision with the pedestrian including the bicycle rider. For example, an Rr pop-up hood, or each of an Rr pop-up hood and an Fr pop-up hood depending on models, is operated in response to the control command input from the ECU 1 as illustrated in FIG. 3 when the collision with the pedestrian is detected by the first collision detection sensor 2 mounted on the Fr bumper, and the external airbag 6 is deployed from a gap at a hood rear end. The external airbag 6 is deployed in a case where the magnitude of the collision that is detected by the first collision detection sensor 2 satisfies a deployment condition for the external airbag 6.

The internal airbag 7 is an airbag for passenger protection that, is deployed in a passenger compartment so as to protect a vehicle passenger during the collision with the external obstacle. For example, the internal airbag 7 is configured to include a front airbag that is installed close to a steering wheel of the vehicle so as to protect a front surface of the passenger and a side airbag that is installed close to a door of the vehicle so as to protect a side surface of the passenger. The internal airbag 7 is deployed in a case where the magnitude of the collision that is detected by the second collision detection sensor 3 satisfies a deployment condition for the internal airbag 7 which is different from the deployment condition for the external airbag.

In a case where the first collision detection sensor 2 is configured to be the pressure sensor and the second collision detection sensor 3 is configured to be the acceleration sensor in the vehicle control device according to this embodiment, the deployment condition for the internal airbag 7 is set for the internal airbag 7 to be deployed when a variable (acceleration G) that shows the magnitude of the collision is equal to or higher than a first threshold (Gth). The deployment condition for the external airbag 6 is set for the external airbag 6 to be deployed when a variable (pressure P), which is different in type from the variable (acceleration G) that shows the magnitude of the collision set as the deployment condition for the internal airbag 7, is equal to or higher than a second threshold (Pth).

In a case where the first collision detection sensor 2 and the second collision detection sensor 3 are configured to be the acceleration sensors in the vehicle control device according to this embodiment, the deployment condition for the internal airbag 7 is set for the internal airbag 7 to be deployed when a variable (acceleration G1) that shows the magnitude of the collision is equal to or higher than a first threshold (G1th). The deployment condition for the external airbag 6 is set for the external airbag 6 to be deployed when a variable (acceleration G2), which is of the same type as the variable (acceleration G1) that shows the magnitude of the collision set as the deployment condition for the internal airbag 7, is equal to or higher than a second threshold (G2th) which is lower than the first threshold (G1th).

The brake actuator 8 is a deceleration device that, decelerates the vehicle by operating a brake in response to the control demand which is input from the ECU 1. Typically, the brake is an electronically controlled brake device. However, the brake may be any brake that generates a braking force in the vehicle wheel of the vehicle. For example, the brake may include a device that generates the braking force in the vehicle wheel of the vehicle by using a parking brake and an engine brake. The brake actuator 8 operates the brake in response to a brake operation by the driver or operates the brake when automatic brake control is performed. The automatic brake control is, for example, control by which the brake is automatically operated during the deployment of the internal airbag 7 so that the vehicle is decelerated and stopped.

The steering actuator 9 is a steering device for vehicle steering that operates a steering mechanism, such as electric power steering in response to the control command input from the ECU 1. The steering actuator 9 operates the steering mechanism in response to a steering wheel operation by the driver or operates the steering mechanism when automatic steering control is performed so that the main vehicle does not deviate from a lane of the main vehicle. The automatic steering control is control by which the steering mechanism is automatically operated, by using the white line information which shows a result of the white line detection by the perimeter monitoring sensor 5, so that the vehicle travels along the white line which is disposed in the travel path.

Referring back to the description of the ECU 1, the details of the various processing units the ECU 1 is provided with will be described. The ECU 1 is provided with at least the airbag control unit 1a, the braking control unit 1b, and the steering control unit 1c.

The airbag control unit 1a is airbag control means for controlling the external airbag 6 to be deployed with the control command output to the external airbag 6 in a case where the magnitude of the collision detected by the first collision detection sensor 2 satisfies the deployment condition for the external airbag 6 (for example, P≧Pth). The airbag control unit 1a may output the control command to the external airbag 6 in a case where the magnitude of the collision detected by the first collision detection sensor 2 satisfies the deployment condition for the external airbag 6 after the pedestrian including the bicycle rider is recognized based on the target object information which shows a result of the target object detection by the perimeter monitoring sensor 5. The airbag control unit 1a is airbag control means for controlling the internal airbag 7 to be deployed with the control command output to the internal airbag 7 in a case where the magnitude of the collision detected by the second collision detection sensor 3 satisfies the deployment condition for the internal airbag 7 (for example, G≧Gth). The airbag control unit 1a may output the control command to the internal airbag 7 in a case where the magnitude of the collision detected by the second collision detection sensor 3 satisfies the deployment condition for the internal airbag 7 after the obstacle other than the pedestrian including the bicycle rider is recognized based on the target object information which shows the result of the target object detection by the perimeter monitoring sensor 5.

The braking control unit 1b is braking control means for performing the automatic brake control with the control command output to the brake actuator 8 when the internal airbag 7 is deployed by the airbag control unit 1a in a case where the deployment condition for the internal airbag 7 is satisfied (for example, G≧Gth). In this embodiment, the braking control unit 1b performs the automatic brake control when the external airbag 6 is deployed by the airbag control unit 1a even in a case where the deployment condition for the external airbag 6 is satisfied (for example, P≧Pth) but the deployment condition for the internal airbag 7 is not satisfied (for example, G<Gth). In other words, the braking control unit 1b operates an automatic emergency brake in conjunction with an ignition signal for the external airbag 6 for pedestrian protection. The braking control unit 1b performs the automatic brake control, by which the brake is automatically operated at the same time as the deployment of the external airbag 6, in this manner, and thus the vehicle is decelerated and stopped.

The vehicle control device according to this embodiment, by which the external airbag 6 is deployed ahead of the front window of the main vehicle even in a condition in which the internal airbag 7 is not deployed, has the braking control unit 1b that performs the automatic brake control when the external airbag 6 is deployed. Accordingly, secondary collision damage that may occur when a forward visibility of the driver is obstructed due to the deployment of the external airbag 6 for pedestrian protection after the detection of the collision with the pedestrian can be suppressed even in the condition in which the internal airbag 7 for passenger protection is not deployed.

In this embodiment, the automatic brake control is released in a case where an accelerator operation by the driver of the main vehicle is detected and an automatic brake control execution time (T) that is counted from initiation of the automatic brake control exceeds a first predetermined time (T1) or the automatic brake control execution time (T) exceeds a second predetermined time (T2) which is longer than the first predetermined time in a case where the vehicle speed detected by the vehicle speed sensor 4 becomes 0 km/h.

In this embodiment, the braking control unit 1b does not release the automatic brake control, even when the accelerator operation by the driver of the main vehicle is detected, in a case where the automatic brake control execution time (T) is within the first predetermined time (T1) (T≦T1) in a condition in which the automatic brake control is released in a case where the accelerator operation by the driver of the main vehicle is detected during the automatic brake control. The braking control unit 1b releases the automatic brake control in a case where the accelerator operation by the driver of the main vehicle is detected in a case where the automatic brake control execution time (T) exceeds the first predetermined time (T1) (T>T1) and the automatic brake control execution time (T) is within the second predetermined time (T2) (T≦T2). In a case where the automatic brake control execution time (T) exceeds the second predetermined time (T2) (T>T2), the braking control unit 1b releases the automatic brake control even when the accelerator operation by the driver is not detected.

The steering control unit 1c is steering control means for performing the automatic steering control (LKA: lane keeping assist) so that the main vehicle does not deviate from the lane of the main vehicle. The steering control unit 1c outputs the control command to the steering actuator 9 so that the vehicle travels along the white line according to the white line information which shows the result of the white line detection by the perimeter monitoring sensor 5. In this embodiment, the steering control unit 1c performs the automatic steering control when an LKA switch is ON and when the external airbag 6 is deployed by the airbag control unit 1a. The steering control unit 1c may perform the automatic steering control with the automatic brake control by the braking control unit 1b that is performed when the external airbag 6 is deployed by the airbag control unit 1a.

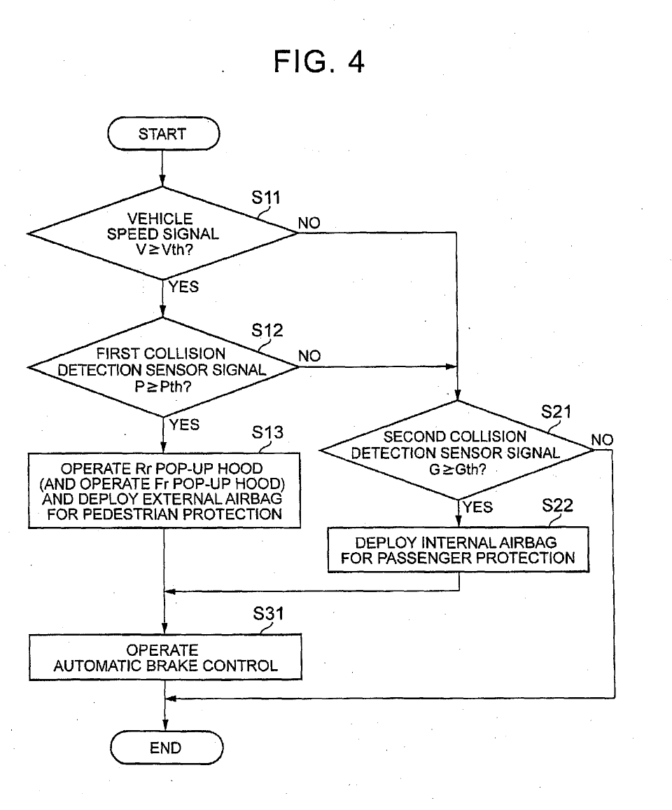

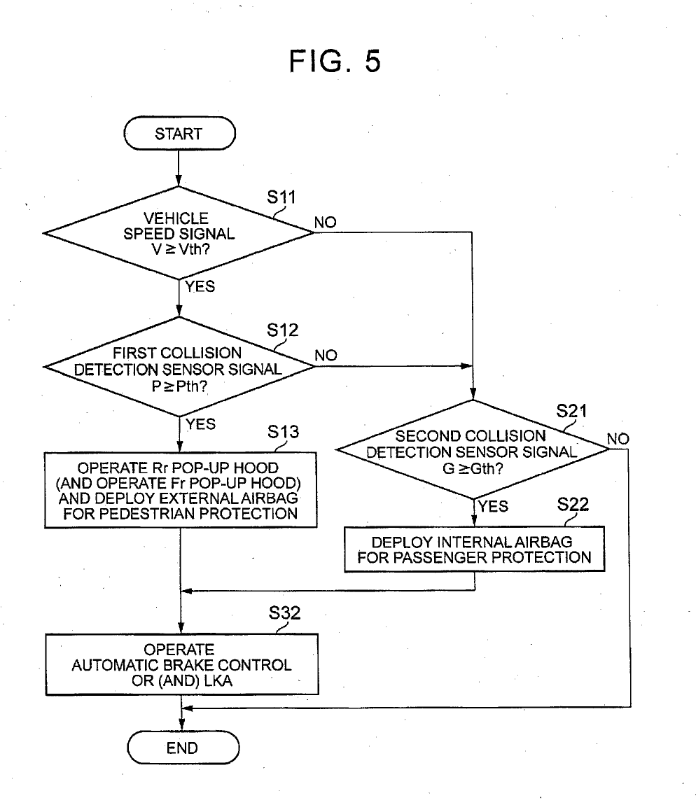

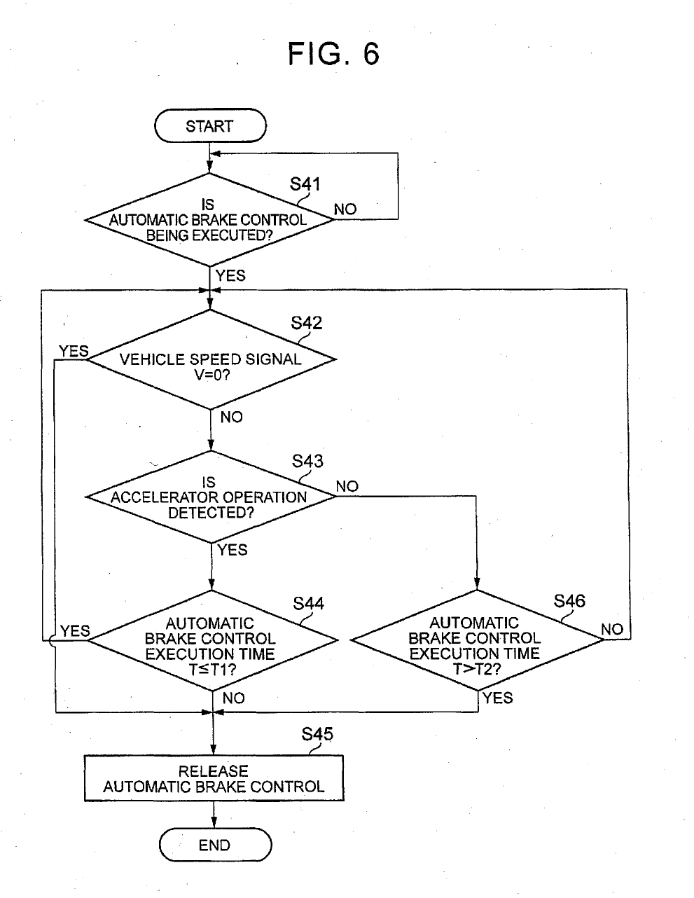

Next, various types of processing executed by the vehicle control device that has the above-described configuration will be described with reference to FIGS. 4 to 6. FIG. 4 is a flowchart illustrating an example of basic processing of the vehicle control device according to the invention. FIG. 5 is a flowchart illustrating another example of the basic processing of the vehicle control device according to the invention. FIG. 6 is a diagram illustrating an example of automatic brake control release processing. The processing illustrated in FIGS. 4 to 6 are repeatedly executed in each short computation cycle (for example, 50 msec and 100 msec).

As illustrated in FIG. 4, the ECU 1 determines whether or not a vehicle speed signal V that is input from the vehicle speed sensor 4 is equal to or higher than a predetermined threshold Vth (Step S11). The predetermined threshold Vth is set to a value (for example, 0 km/h to 10 km/h) at which it can be determined that the vehicle is not in a stopped or slow-moving state. In a case where the ECU 1 determines that the vehicle speed signal V is not equal to or higher than the threshold Vth, that is, the vehicle speed signal V is lower than the threshold Vth in Step S11 (Step S11: No), the processing proceeds to Step S21. In a case where the ECU 1 determines that the vehicle speed signal V is equal to or higher than the predetermined threshold Vth (Step S11: Yes), the processing proceeds to the following Step S12.

The ECU 1 determines whether or not the first collision detection sensor signal (pressure P that is the variable which shows the magnitude of the collision in a case where the first collision detection sensor 2 is the pressure sensor in FIG. 4) that is input from the first collision detection sensor 2 is equal to or higher than the second threshold (Pth in FIG. 4) (Step S12). In a case where the ECU 1 determines that the first collision detection sensor signal P is not equal to or higher than the second threshold Pth, that is, the first collision detection sensor signal P is lower than the second threshold Pth in Step S12 (Step S12: No), the processing proceeds to Step S21. In a case where the ECU 1 determines that the first collision detection sensor signal P is equal to or higher than the second threshold Pth (Step S12: Yes), the processing proceeds to the following Step S13.

The ECU 1 deploys the external airbag 6 for pedestrian protection from the gap at the hood rear end by operating the Rr pop-up hood or operating each of the Rr pop-up hood and the Fr pop-up hood (Step S13). The airbag control unit 1a of the ECU 1 controls the external airbag 6 to be deployed with the control command output to the external airbag 6 in a case where the magnitude of the collision that is detected by the first collision detection sensor 2 satisfies the deployment condition for the external airbag 6 (P≧Pth in FIG. 4) in Step S13. Then, the processing,proceeds to the following Step S31.

Then, the ECU 1 operates the automatic emergency brake in conjunction with the ignition signal for the external airbag 6 for pedestrian protection that is deployed in Step S13 (Step S31). In a case where the deployment condition for the external airbag 6 is satisfied (for example, P≧Pth) in Step S31, the braking control unit 1b of the ECU 1 performs the automatic brake control when the external airbag 6 is deployed by the airbag control unit 1a. Then, this processing is terminated.

Description of this processing will continue from the processing in Step S21. In a case where it is determined that the vehicle speed signal V is not equal to or higher than the threshold Vth, that is, the vehicle speed signal V is lower than the threshold Vth in Step S11 (Step S11: No) or in a case where it is determined that the first collision detection sensor signal P is not equal to or higher than the second threshold Pth, that is, the first collision detection sensor signal P is lower than the second threshold Pth in Step S12 (Step S12: No), the ECU 1 determines whether or not the second collision detection sensor signal that is input from the second collision detection sensor 3 (acceleration G that is the variable which shows the magnitude of the collision in a case where the second collision detection sensor 3 is the acceleration sensor in FIG. 4) is equal to or higher than the first threshold (Gth in FIG. 4) (Step S21). After the ECU 1 determines that the second collision detection sensor signal G is not equal to or higher than the first threshold Gth, that is, the second collision detection sensor signal G is lower than the first threshold Gth in Step S21 (Step S21: No), this processing is terminated. In a case where the ECU 1 determines that the second collision detection sensor signal G is equal to or higher than the first threshold Gth (Step S21: Yes), the processing proceeds to the following Step S22.

The ECU 1 deploys the internal airbag 7 for passenger protection (Step S22). In a case where the magnitude of the collision that is detected by the second collision detection sensor 3 satisfies the deployment condition for the internal airbag 7 (G≧Gth in FIG. 4) in Step S22, the airbag control unit 1a of the ECU 1 controls the internal airbag 7 to be deployed with the control command output to the internal airbag 7. Then, the processing proceeds to the following Step S31.

Then, the ECU 1 operates the automatic emergency brake in conjunction with the ignition signal for the internal airbag 7 for passenger protection that is deployed in Step S22 (Step S31). In a case where the deployment condition for the internal airbag 7 is satisfied (for example, G≧Gth) in Step S31, the braking control unit 1b of the ECU 1 performs the automatic brake control when the internal airbag 7 is deployed by the airbag control unit 1a. Then, this processing is terminated.

As described above, the vehicle control device according to this embodiment can deploy the external airbag for pedestrian protection and automatically operate the brake, even in the condition in which the internal airbag for passenger protection is not deployed, after the detection of the collision with the pedestrian. Accordingly, with the vehicle control device according to this embodiment, the secondary collision damage that may occur when the forward visibility of the driver is obstructed due to the deployment of the external airbag for pedestrian protection after the detection of the collision with the pedestrian can be suppressed.

In this embodiment, the lane keeping assist (LKA) may be operated in conjunction with the ignition signal for the external airbag 6 for pedestrian protection as illustrated in FIG. 5. Processing from Steps S11 to S13 and Steps S21 to S22 in FIG. 5 are similar to processing from Steps S11 to S13 and Steps S21 to S22 in FIG. 4, and thus description thereof will be omitted herein.

In Step S32 in FIG. 5, the automatic steering control (KLA) may be performed instead of the automatic brake control or the automatic steering control may be performed with the automatic brake control. In Step S32, the braking control unit 1b of the ECU 1 can perform the automatic brake control when the external airbag 6 is deployed by the airbag control unit 1a in Step S13 or when the internal airbag 7 is deployed by the airbag control unit 1a in Step S22. Alternatively, the steering control unit 1c of the ECU 1 may perform the automatic steering control when the external airbag 6 is deployed by the airbag control unit 1a in Step S13 or the internal airbag 7 is deployed by the airbag control unit 1a in Step S22. The steering control unit 1c may perform the automatic steering control with the automatic brake control by the braking control unit 1b when the external airbag 6 is deployed by the airbag control unit 1a in Step S13 or when the internal airbag 7 is deployed by the airbag control unit 1a in Step S22. The automatic steering control LKA is also performed after the detection of the collision with the pedestrian as described above, and thus the secondary collision damage that may occur when the forward visibility of the driver is obstructed due to the deployment of the external airbag 6 for pedestrian protection can be further suppressed.

In this embodiment, the pressure P the pressure sensor detects by using the first collision detection sensor signal in Step S12 and the acceleration G the acceleration sensor detects by using the second collision detection sensor signal in Step S21 have been described in the processing in FIGS. 4 and 5. However, the invention is not limited thereto.

For example, the ECU 1 may determine whether or not the first collision detection sensor signal that is input from the first collision detection sensor 2 (acceleration G2 that is the variable which shows the magnitude of the collision in a case where the first collision detection sensor 2 is the acceleration sensor in this example) is equal to or higher than the second threshold (G2th in this example) in Step S12 (Step S12) in a case where the first collision detection sensor 2 and the second collision detection sensor 3 are configured to be the acceleration sensors. In a case where the ECU 1 determines that the first collision detection sensor signal G2 is not equal to or higher than the second threshold G2th, that is, the first collision detection sensor signal G2 is lower than the second threshold G2th in Step S12 (Step S12: No), the processing proceeds to Step S21. In a case where the ECU 1 determines that the first collision detection sensor signal G2 is equal to or higher than the second threshold G2th (Step S12: Yes), the processing proceeds to the following Step S13.

In Step S21, the ECU 1 determines whether or not the second collision detection sensor signal that is input from the second collision detection sensor 3 (acceleration G1 that is the variable which shows the magnitude of the collision in a case where the second collision detection sensor 3 is the acceleration sensor in this example) is equal to or higher than the first threshold (G1th in this example) (Step S21). Herein, a value that is larger than the second threshold G2th is set as the first threshold G1th (G1th>G2th in this example). After the ECU 1 determines that the second collision detection sensor signal G1 is not equal to or higher than the first threshold G1th, that is, the second collision detection sensor signal G1 is lower than the first threshold G1th in Step S21 (Step S21: No), this processing is terminated. In a case where the ECU 1 determines that the second collision detection sensor signal G1 is equal to or higher than the first threshold G1th (Step S21: Yes), the processing proceeds to the following Step S22. In this case, only one collision detection sensor may be used in common as the first collision detection sensor 2 and the second collision detection sensor 3.

The automatic brake control release processing will be described with reference to FIG. 6. Processing illustrated in FIG. 6 is executed in combination with the processing in FIGS. 4 and 5.

As illustrated in FIG. 6, the ECU 1 determines whether or not the automatic brake control is being executed by the steering control unit 1c (Step S41). In a case where the ECU 1 determines that the automatic brake control is not being executed in Step S41 (Step S41: No), the processing in Step S41 is repeated. In a case where the ECU 1 determines that the automatic brake control is being executed (Step S41: Yes), the processing proceeds to the following Step S42.

The ECU 1 determines whether or not the vehicle speed signal V that is input from the vehicle speed sensor 4 is zero (Step S42). The ECU 1 releases the automatic brake control (Step S45) in a case where it is determined that the vehicle speed signal V is zero, that is, the vehicle is stopped in Step S42 (Step S42: Yes). Then, this processing is terminated. In a case where the ECU 1 determines that the vehicle speed signal V is not zero, that is, the vehicle is not stopped (Step S42: No), the processing proceeds to the following Step S43.

The ECU 1 determines whether or not the accelerator operation by the driver is detected (Step S43). In a case where it is determined that the accelerator operation is detected in Step S43 (Step S43: Yes), the ECU 1 determines whether or not the automatic brake control execution time T is within the first predetermined time T1 (Step S44). The automatic brake control execution time T is time that is counted from the determination that the automatic brake control is being executed in Step S41.

In a case where the ECU 1 determines that the automatic brake control execution time T is within the first predetermined time T1 in Step S44 (Step S44: Yes), the processing returns to Step S42. In other words, the braking control unit 1b of the ECU 1 does not release the automatic brake control within the first predetermined time T1 even when the accelerator operation by the driver of the main vehicle is detected during the automatic brake control. In a case where the ECU 1 determines that the automatic brake control execution time T is not within the first predetermined time T1, that is, the automatic brake control execution time T exceeds the predetermined time T1 (Step S44: No), the processing proceeds to Step S45 and the automatic brake control is released. Then, this processing is terminated.

Referring back to the processing in Step S43, description of this processing will continue. In a case where it is determined that the accelerator operation is not detected in Step S43 (Step S43: No), the ECU 1 determines whether or not the automatic brake control execution time T exceeds the second predetermined time T2 (Step S46). A value that is larger than the first predetermined time T1 is set as the second predetermined time T2.

In a case where the ECU 1 determines that the automatic brake control execution time T does not exceed the second predetermined time T2, that is, the automatic brake control execution time T is shorter than the second predetermined time in Step S46 (Step S46: No), the processing returns to Step S42. In a case where the ECU 1 determines that the automatic brake control execution time T exceeds the second predetermined time T2 (Step S46: Yes), the processing proceeds to Step S45 and the automatic brake control is released. In other words, the braking control unit 1b of the ECU 1 releases the automatic brake control, even when the accelerator operation by the driver is not detected, in a case where the second predetermined time T2 that is longer than the first predetermined time T1 is exceeded. Then, this processing is terminated.

1. A vehicle control device comprising:
a first collision detection sensor that detects a collision with a pedestrian;
a second collision detection sensor that detects a collision with an external obstacle;
an external airbag that is deployed ahead of a front window of a main vehicle so as to protect the pedestrian;
an internal airbag that is deployed in a passenger compartment so as to protect a passenger in the main vehicle;
an airbag control unit that deploys the external airbag in a case where a magnitude of the collision detected by the first collision detection sensor satisfies a deployment condition for the external airbag and deploying the internal airbag in a case where a magnitude of the collision detected by the second collision detection sensor satisfies a deployment condition for the internal airbag which is different from the deployment condition for the external airbag; and
a braking control unit that performs automatic brake control when the internal airbag is deployed by the airbag control unit in a case where the deployment condition for the internal airbag is satisfied and performing the automatic brake control when the external airbag is deployed by the airbag control unit in a case where the deployment condition for the external airbag is satisfied but the deployment condition for the internal airbag is not satisfied.

2. The vehicle control device according to claim 1, wherein
the deployment condition for the internal airbag is set for the internal airbag to be deployed when a variable showing the magnitude of the collision is equal to or higher than a first threshold, and
the deployment condition for the external airbag is set for the external airbag to be deployed when a variable different in type from the variable showing the magnitude of the collision set as the deployment condition for the internal airbag is equal to or higher than a second threshold.

3. The vehicle control device according to claim 1, wherein
the deployment condition for the internal airbag is set for the internal airbag to be deployed when a variable showing the magnitude of the collision is equal to or higher than a first threshold, and
the deployment condition for the external airbag is set for the external airbag to be deployed when a variable of a same type as the variable showing the magnitude of the collision set as the deployment condition for the internal airbag is equal to or higher than a second threshold lower than the first threshold.

4. The vehicle control device according to claim 1, further comprising a steering control unit that performs automatic steering control so that the main vehicle does not deviate from a lane of the main vehicle,
wherein the steering control unit performs the automatic steering control with the automatic brake control by the braking control unit performed when the external airbag is deployed by the airbag control unit.

5. The vehicle control device according to claim 1, wherein
the braking control unit releases the automatic brake control in a case where an accelerator operation by a driver of the main vehicle is detected during the automatic brake control, wherein
the braking control unit does not release the automatic brake control within a first predetermined time, even when the accelerator operation is detected and
the braking control unit releases the automatic brake control in a case where a second predetermined time longer than the first predetermined time is exceeded, even when the accelerator operation by the driver is not detected.
